(19) United States
(12) Patent Application Publication
(10) Pub. No.: US 2018/0009408 A1
(43) Pub. Date: Jan. 11, 2018

(54) Adjustable Torso Harness

(71) Applicants: Eric Lee Brodie, West Newton, MA (US); Seema Malik Brodie, West Newton, MA (US)

(72) Inventors: Eric Lee Brodie, West Newton, MA (US); Seema Malik Brodie, West Newton, MA (US)

(21) Appl. No.: 15/618,116

(22) Filed: Jun. 8, 2017

Related U.S. Application Data
(60) Provisional application No. 62/347,595, filed on Jun. 8, 2016.

(51) Int. Cl. B60R 22/12; B60R 22/18; A44B 11/25

(52) U.S. Cl. CPC B60R 22/12; A44B 11/2503; B60R 22/18

(57) ABSTRACT

An adjustable torso harness used to counter horizontal forces that allows for a fully customizable fit while maintaining strength across the horizontal portion of the wearer's chest, affording restraint when attached to a retractor or similar inertia-sensitive lanyard.

### CROSS-REFERENCE TO RELATED APPLICATIONS

The present application claims priority under 35 USC §119(e) to U.S. Provisional Application No. 62/347,595, filed Jun. 8, 2016, the disclosure of which is incorporated herein by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is the result of a specific need for a human-wearable torso harness that is adjustable, lightweight, and breathable, yet able to withstand forces of horizontal movement when the wearer of said harness is tethered, via a caribiner, to webbing, which itself is then attached to a retractor mechanism.

Several examples of safety harnesses have been found, although each differs materially from the presently disclosed invention.

For example, a harness is referenced in an occupant restraint or confinement system that uses a vest-type restraint in U.S. Pat. No. 6,896,291, issued to Peterson on May 24, 2005, which discloses a chest harness incorporating panels, to which webbing is anchored to the vehicle's interior ceiling using via a rotatable anchor.

U.S. Pat. No. 6,962,232, issued to Diggle, et al. on Nov. 8, 2005, discloses a torso harness designed to prevent injury to utility pole workers, which harness wraps around the waist and legs only and incorporates a fair amount of hardware.

U.S. Pat. No. 6,101,979, issued to Wilson, et al. on Aug. 15, 2000, which discloses a belt-style torso harness for pets designed to prevent injury in automobiles. Similarly, U.S. Pat. No. 4,715,618, issued to Harris on Dec. 29, 1987, discloses a jacket-style torso harness for pets for use in vehicles.

U.S. Pat. No. 5,664,844, issued to Greene on Sep. 9, 1987 discloses a chest harness for securing children or adults to shopping cart seats or baskets, although the design incorporates additional hardware but may not be suitable for motor vehicle use.

U.S. Pat. No. 4,738,413, issued to Spinosa, et al. on Apr. 19, 1988, discloses a chest harness that incorporates a cross-chest belt configuration as well as leg restraints. Other examples of safety harnesses incorporate chest and leg attachments and include additional corresponding hardware, such as U.S. Pat. No. 8,353,386, issued to Helm on Jan. 15, 2013; U.S. Pat. No. 7,025,171, issued to Cox on Apr. 11, 2006; and U.S. Pat. No. 6,739,427 issued to Gayetty on May 25, 2004.

The primary difference between the foregoing examples and the present invention is the deliberate minimum of hardware, the focus on chest-only weight bearing, and the advantages of adjustability, breathability, and strength. The intent of this invention is to incorporate it into a safety system that so requires this particular type of harness, where horizontal forces are the primary risk and concern, and where the primary force bearing structure is the ribcage of the wearer.

Further objects and advantages of the technology described herein will be apparent from the following detailed description of a presently preferred embodiment that is illustrated schematically in the accompanying drawing identified as FIG. 1.

### SUMMARY OF THE INVENTION

The technology described here provides a torso harness for restraining persons on a moving vehicle. When attached to a retractor that is in turn securely anchored to a moving vehicle, the torso harness permits an interface between the passenger and the retractor. In the event of a panic stop or other hard braking event, the retractor's deployment of webbing is immediately stopped, thereby stopping the moment of the harness and the person wearing it. The main force bearing aspect of the harness is the horizontal strap that encircles the wearer's ribcage; by spreading that force across the ribcage, the risk of harm from the harness itself is minimized.

### BRIEF DESCRIPTION OF THE DRAWINGS

FIG. 1 is a detailed drawing of the front view of the typical embodiment of the torso harness as constructed and used.

### DETAILED DESCRIPTION OF THE INVENTION

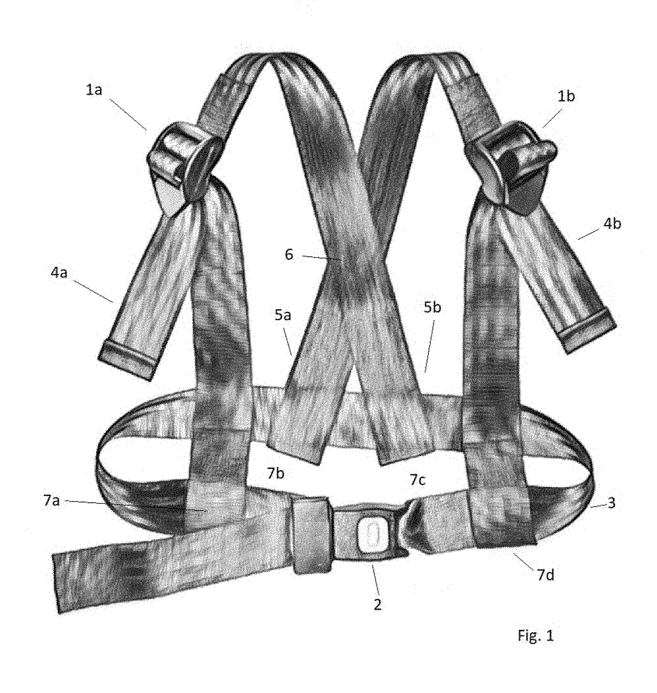

FIG. 1 depicts the torso harness, which is constructed primarily from 2-inch wide seat-belt grade webbing. Adjustments to allow a comfortable yet snug fit are accomplished by way of the use of strap adjusters 1a, 1b found on each side of the front of the chest, and from the adjuster in the buckle 2 used in the front of the horizontal webbing 3. The buckle 2 is spring-loaded and is of the same construction needed to pass applicable motor vehicle safety standards.

The height of the shoulder straps is adjusted by pulling or releasing webbing on the front strap adjusters 4a, 4b. The rear straps 5a, 5b are crossed with a fixed stitch 6 to maintain the cross shape, and then loop over the shoulders, terminating in the strap adjusters 1a, 1b.

A major advantage of this design over others is the customizability of every part of the harness. Webbing loops found at the intersection of the vertical webbing and horizontal webbing 7a, 7b, 7c, 7d allow for every portion of the webbing to “float” along the horizontal webbing, allowing the rear cross at 7b, 7c to be centered over a variety of sizes of wearers, from the very small to the very large. Once the rear cross is centered, the remaining vertical webbing 7a, 7d can be repositioned as needed to ensure wearer comfort and fit. The horizontal webbing is also easily repositioned so that the buckle 2 can be centered in front of the chest of the wearer, regardless of the size of the wearer's chest.

A further advantage of this over other designs is that the design is relatively lightweight, using a minimal amount of hardware. A further advantage of the design is that the interface between the retractor and the horizontal member may be the horizontal webbing 3 itself; a separate “D” ring is unneeded so long as there is a minimal amount of friction between retractor and the horizontal webbing. By way of example, a smooth carabiner suitable for rock climbing applications would provide sufficient strength while being lightweight and affording a smooth surface unlikely to wear into the webbing. The use of a carabiner offers the further advantage of the carabiner being easily replaced in the event of wear.

Another advantage of this over other designs is its comfort. Because of the complete adjustability of the webbing, the webbing is allowed to lay flat rather than be forced into the skin of the wearer, avoiding potential discomfort.

A further advantage of this over other designs is its washability. Because the construction is recommended to be entirely made of synthetic materials, it is unaffected by water and mild detergents.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. For example, but not by way of limitation, it has been the inventors' experience that while one size can accommodate a wide range of body shapes, it may be necessary to construct harnesses of variable ranges so that particularly large persons are not constrained by a lack of sufficient webbing, and that particularly small people are not burdened with an excess of unneeded webbing. The invention should therefore not be limited by the above described embodiment, method, and examples, but by all embodiments and methods within the scope and spirit of the invention as claimed.

We claim:

1. A human-wearable chest harness comprising:
a chest strap to be worn going horizontally around the ribcage, said strap to be the main weight-bearing support designed to bear most of the stress in the event of a sudden braking or decelerating event;
an adjustable buckle that allows the chest strap to be fastened together forming a loop of appropriate length for the wearer;
a pair of two-piece shoulder straps attached to the horizontal chest strap by way of sewn loops at each end of the shoulder straps, through which the horizontal chest strap passes;
a belt adjuster on each shoulder strap that allows for the length of the shoulder strap to be adjusted to appropriate length so that the chest strap is supported around the ribcage; and
construction of said shoulder straps so that they are crossed on the backside of the chest strap and stitched or affixed so that the cross is a fixed feature of the shoulder straps.

2. The harness as described in claim 1, wherein the cross of the backside of the shoulder straps forms a triangle with the horizontal chest strap, where a carabiner can be attached to the horizontal chest strap.

3. The harness as described in claim 1, wherein all buckles and adjusters are sewn in compliance with applicable motor vehicle safety standards for seat belt webbing.

4. The harness as described in claim 1, wherein straps are made from seat belt webbing that is compliant with applicable motor vehicle safety standards for seat belt webbing.
